(19) United States
(12) Patent Application Publication
(10) Pub. No.: US 2024/0389089 A1
(43) Pub. Date: Nov. 21, 2024

(54) SYMBOL SCRAMBLING FOR COMBINING

(71) Applicant: QUALCOMM Incorporated, San Diego, CA (US)

(72) Inventors: Igor GUTMAN, Hod HaSharon (IL); Tao LUO, San Diego, CA (US)

(21) Appl. No.: 18/352,806

(22) Filed: Jul. 14, 2023

Related U.S. Application Data
(60) Provisional application No. 63/502,310, filed on May 15, 2023.

(51) Int. Cl. H04W 72/044; H04L 5/00

(52) U.S. Cl. CPC H04W 72/0466; H04L 5/0048

(57) ABSTRACT

Various aspects of the present disclosure generally relate to wireless communication. In some aspects, a wireless communication device (WCD) may transmit signals via a set of symbols, the set of symbols including a first symbol carrying a first signal that has first scrambling applied and a second symbol carrying the first signal that has second scrambling applied, the first scrambling being different from the second scrambling. Numerous other aspects are described.

### CROSS-REFERENCE TO RELATED APPLICATION

This patent application claims priority to U.S. Provisional Patent Application No. 63/502,310, filed on May 15, 2023, entitled “SYMBOL SCRAMBLING FOR COMBINING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for symbol scrambling for combining.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a wireless communication device (WCD). The method may include transmitting signals via a set of symbols, the set of symbols including a first symbol carrying a first signal that has first scrambling applied and a second symbol carrying the first signal that has second scrambling applied, the first scrambling being different from the second scrambling.

Some aspects described herein relate to a non-transitory computer-readable medium that stores a set of instructions for wireless communication by a WCD. The set of instructions, when executed by one or more processors of the WCD, may cause the WCD to transmit signals via a set of symbols, the set of symbols including a first symbol carrying a first signal that has first scrambling applied and a second symbol carrying the first signal that has second scrambling applied, the first scrambling being different from the second scrambling.

Some aspects described herein relate to a WCD for wireless communication. The wireless communication device may include one or more memories and one or more processors coupled to the one or more memories. The one or more processors may be configured to transmit signals via a set of symbols, the set of symbols including a first symbol carrying a first signal that has first scrambling applied and a second symbol carrying the first signal that has second scrambling applied, the first scrambling being different from the second scrambling.

Some aspects described herein relate to an apparatus for wireless communication. The apparatus may include means for transmitting signals via a set of symbols, the set of symbols including a first symbol carrying a first signal that has first scrambling applied and a second symbol carrying the first signal that has second scrambling applied, the first scrambling being different from the second scrambling.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram of examples associated with automatic gain control (AGC) in a sidelink communication, in accordance with the present disclosure.

FIG. 5 is a diagram illustrating an example of communicating using nonlinear (NL) distortion, in accordance with the present disclosure.

FIG. 6 is a diagram of an example associated with symbol scrambling for combining in a communication from a first wireless communication device (WCD) to a second WCD, in accordance with the present disclosure.

FIG. 7 is a diagram of an example associated with symbol scrambling for sensing signals, in accordance with the present disclosure.

FIG. 8 is a diagram illustrating an example process performed, for example, by a WCD, in accordance with the present disclosure.

FIG. 9 is a diagram of an example apparatus for wireless communication, in accordance with the present disclosure.

### DETAILED DESCRIPTION

In some networks, communications between a first wireless communication device (WCD) and a second WCD may use automatic gain control (AGC) to assist with calibrating amplifiers in a receiver to provide sufficient amplification of a received signal. Over-amplification can cause a power amplifier to operate in a non-linearity (NL) region. The NL region is a power level range where a change of input power to the power amplifier fails to produce a linearly increasing output power. For example, in an NL region, an input of A Decibels (dBs) produces an output of 2A dBs, and an input of B dBs produces an output of 1.8B dBs.

Various aspects relate generally to signal scrambling. Some aspects more specifically relate to scrambling a signal with a first scrambling on a first symbol of a communication and scrambling the signal with a second scrambling on a second symbol of the communication. In some examples, a sensing signal (e.g., for use in positioning information and/or RADAR, among other examples) may include a signal transmitted via multiple symbols to increase sensitivity of a measurement of a reflection of the sensing signal after reflecting off of an object. Based at least in part on using different scrambling on the multiple symbols, a WCD may reduce self-interference and improve isolation of the reflection of the sensing signal. This may support improved positioning of the object.

In some aspects, a first WCD may transmit a communication (e.g., a sidelink communication) with multiple symbols allocated for AGC. Based at least in part on the first WCD transmitting an AGC signal with a first scrambling on a first AGC symbol and transmitting the AGC signal with a second scrambling on a second AGC symbol, the WCD may calibrate AGC gain and gain additional information from the scrambling. For example, the WCD may descramble the AGC signal on each of the first and second AGC symbols and then combine the descrambled signal from the first symbol and from the second symbol. Based at least in part on the AGC signal having different scrambling in an over-the-air signal, the NL may be at least partially canceled when the AGC signal is combined after descrambling.

Particular aspects of the subject matter described in this disclosure can be implemented to realize one or more of the following potential advantages. In some examples, by scrambling the signal (e.g., an AGC signal or a sensing signal) with different scrambling on different symbols, the described techniques can be used to reduce an effect of nonlinearity while supporting calibration of amplifiers. In this way, WCDs may communicate with an improved signal-to-interference-plus-noise ratio (SINR) and/or signal-to-noise ratio (SNR), which may improve spectral efficiency and/or reduce communication errors. Based at least in part on improving spectral efficiency and/or reducing communication errors, the WCDs may conserve communication, processing, power, and/or networking resources that may have otherwise been consumed based at least in part on communicating with reduced modulation orders, coding rates, and/or layers or detecting and correcting communication errors.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

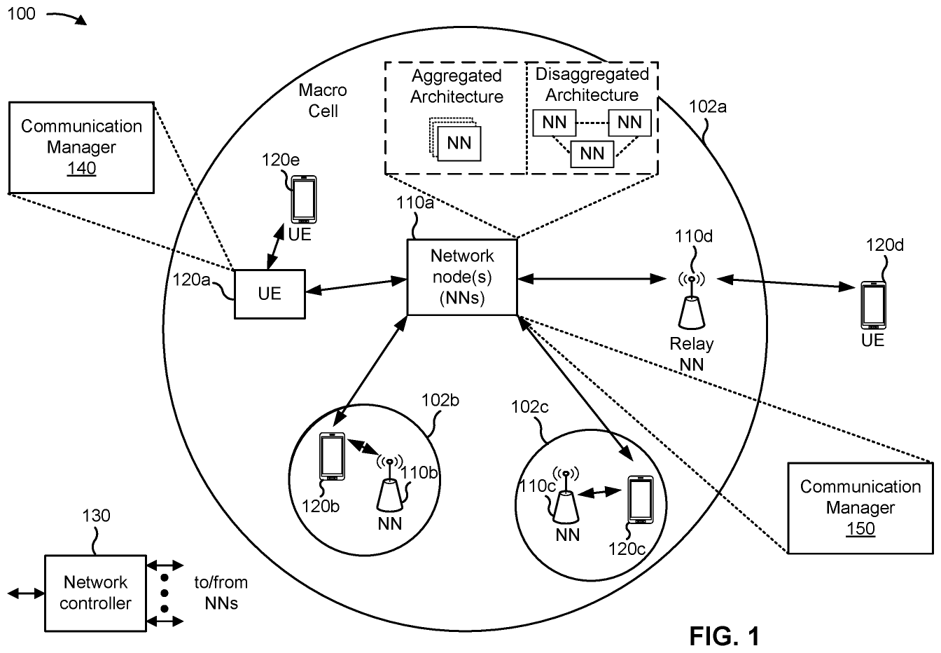

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a WCD (e.g., UE 120 or network node 110) may include a communication manager 140 or 150. As described in more detail elsewhere herein, the communication manager 140 or 150 may transmit signals via a set of symbols, the set of symbols including a first symbol carrying a first signal that has first scrambling applied and a second symbol carrying the first signal that has second scrambling applied, the first scrambling being different from the second scrambling. Additionally, or alternatively, the communication manager 140 or 150 may perform one or more other operations described herein.

As indicated above, FIG. 1 is provided as an example. Other examples may differ from what is described with regard to FIG. 1.

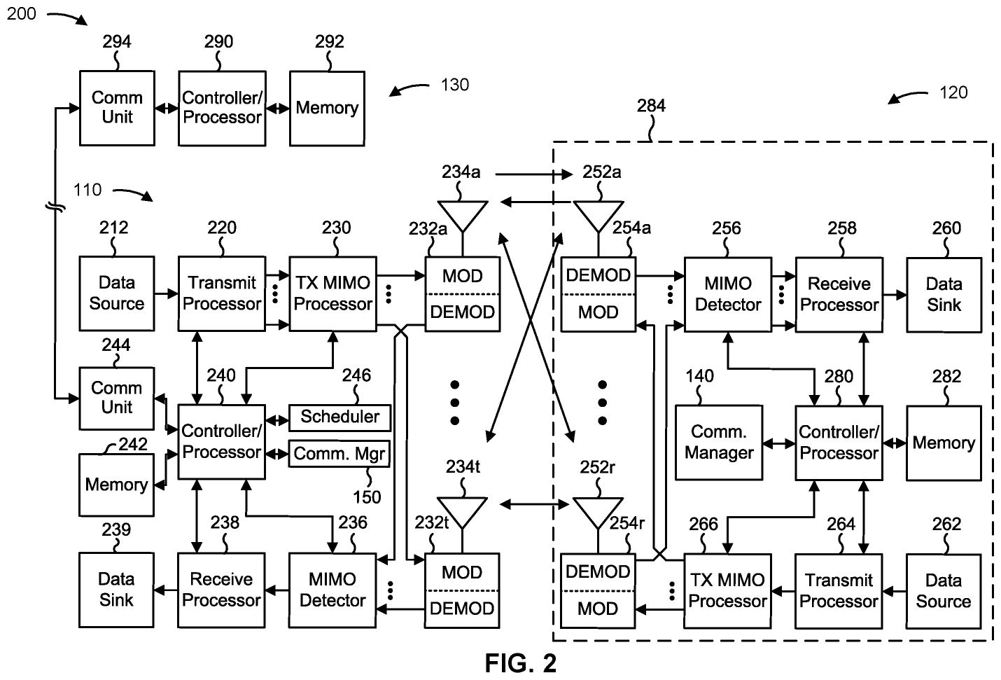

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

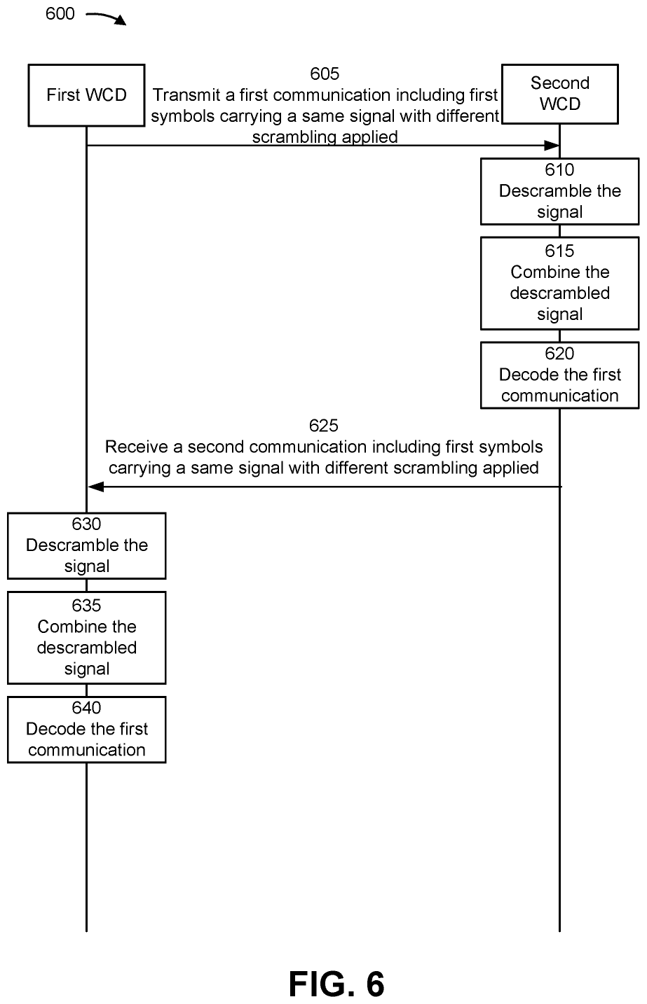

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-9).

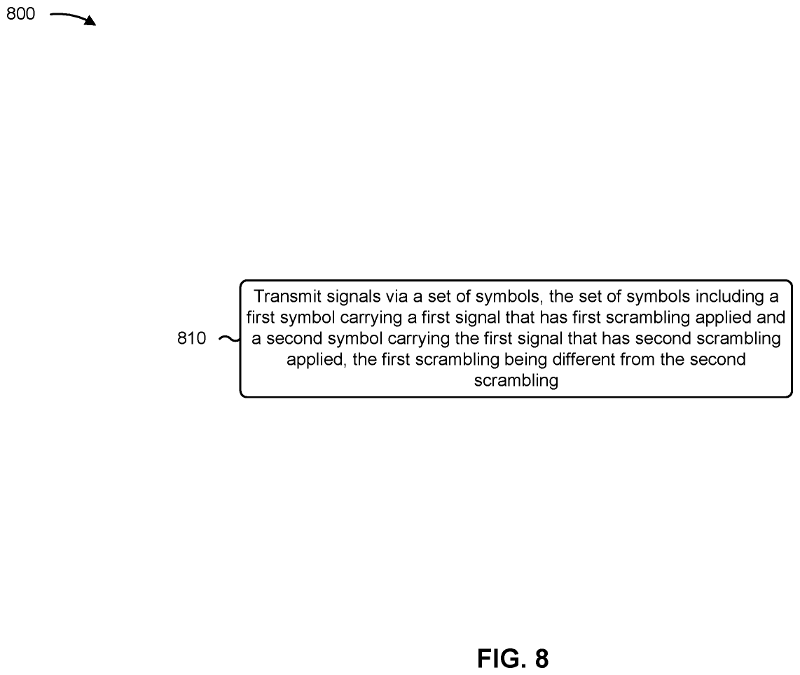

The controller/processor 240 of the network node 110, the controller/processor 280 of the UE 120, and/or any other component(s) of FIG. 2 may perform one or more techniques associated with symbol scrambling for combining, as described in more detail elsewhere herein. In some aspects herein, the WCD may transmit signals via a set of symbols, the set of symbols including a first symbol carrying a first signal that has first scrambling applied and a second symbol carrying the first signal that has second scrambling applied, the first scrambling being different from the second scrambling. In some aspects, the network node 110 or the UE 120. For example, the controller/processor 240 of the network node 110, the controller/processor 280 of the UE 120, and/or any other component(s) of FIG. 2 may perform or direct operations of, for example, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, and/or other processes as described herein. In some examples, executing instructions may include running the instructions, converting the instructions, compiling the instructions, and/or interpreting the instructions, among other examples.

In some aspects, a WCD includes means for transmitting signals via a set of symbols, the set of symbols including a first symbol carrying a first signal that has first scrambling applied and a second symbol carrying the first signal that has second scrambling applied, the first scrambling being different from the second scrambling. In some aspects, the means for the WCD to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the WCD to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

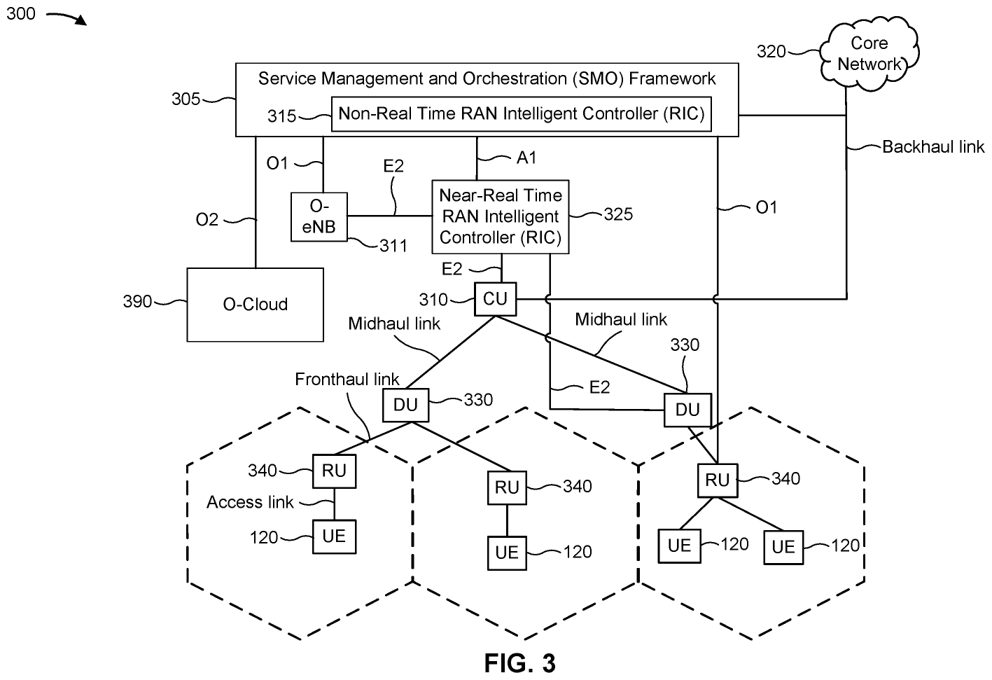

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

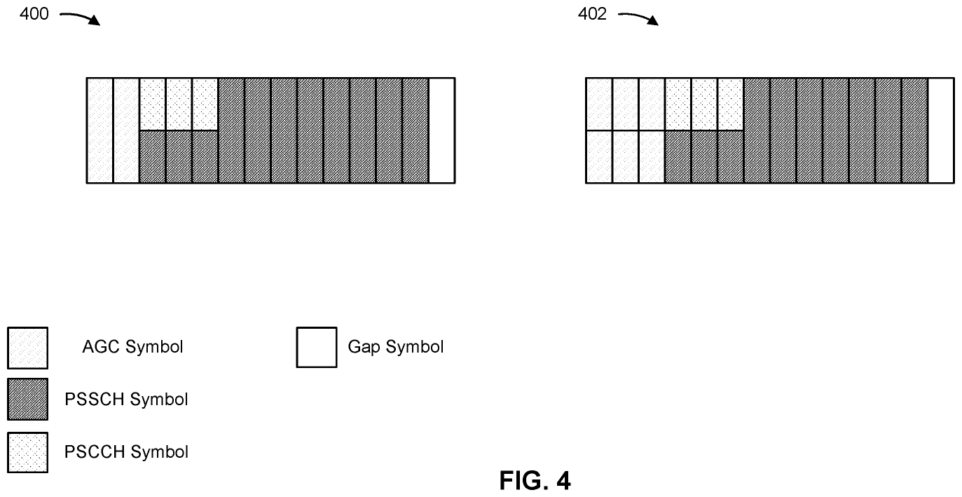

FIG. 4 is a diagram of examples 400 and 402 associated with AGC in a sidelink communication, in accordance with the present disclosure. As shown in examples 400 and 402, a communication may include symbols allocated to AGC, physical sidelink shared channel (PSSCH), physical sidelink control channel (PSCCH), and/or a gap symbol for transmit/receive switching and/or for timing calibration. As shown in example 400, the communication may include two AGC symbols. As shown in example 402, the communication may include three AGC symbols. The AGC symbols may be used for a receiving WCD to calibrate (e.g., configure) an AGC gain for remaining symbols of the communication. In some networks, the communication may have a number of AGC symbols that is based at least in part on subcarrier spacing of a channel on which the transmitting WCD transmits the communication.

In some configurations, a transmitting WCD may transmit the communication with an AGC signal on the AGC symbols where the AGC signal is a repetition of a signal on first non-AGC symbols (e.g., a PSSCH symbol and/or a PSCCH symbol). The AGC signal may be the same on both AGC symbols. In this way, the receiving WCD may be unable to remove NL from the AGC symbols.

As indicated above, FIG. 4 is provided as an example. Other examples may differ from what is described with regard to FIG. 4.

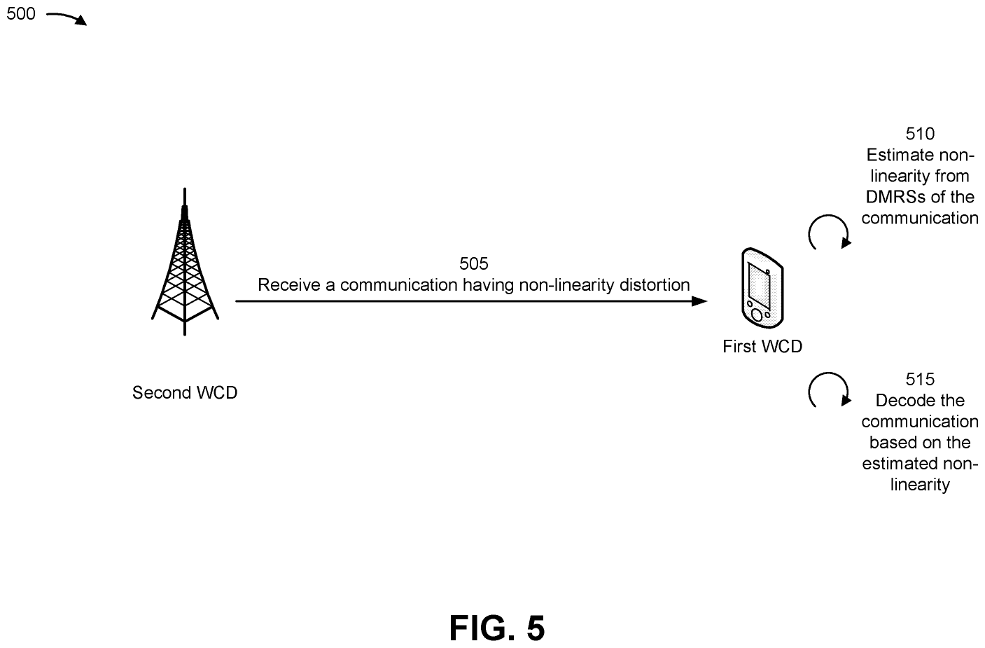

FIG. 5 is a diagram illustrating an example 500 of communicating using nonlinear (NL) distortion, in accordance with the present disclosure. As shown in FIG. 5, a first WCD and a second WCD may communicate based on transmitting communications with NL distortion and attempting to decode communications with NL distortion. The first WCD may include or may be included in a UE (e.g., UE 120) or a network node (e.g., network node 110 or a repeater). The second WCD may include or may be included in a UE (e.g., UE 120) or a network node (e.g., network node 110 or a repeater).

As shown by reference number 505, the second WCD may transmit, and the first WCD may receive, a communication having NL distortion. The second WCD may transmit the communication having NL distortion based on the second WCD using non-linear components, such as high-power power amplifiers (PAs) with limited linear dynamic range (DR), and a polynomial response. The NL distortions may be classified as in-band distortion, which affects a link performance (e.g., an error vector magnitude (EVM)), and out-band distortion, which corresponds to an amount of adjacent channel interference (ACI).

To reduce NL distortions, power output back-off (boOut) may be used to reduce a transmission power used to transmit the communication. However, an increase in boOut may cause a reduction in power amplifier efficiency (PAE). The reduction of PAE may correspond to a reduction of power transmitted on the channel and an increase in energy dissipated as heat.

As shown by reference number 510, the first WCD may estimate NL of the communication using DMRSs or other reference signals of the communication. For example, the second node may use a sequence associated with the DMRSs to estimate NL distortion of the signal and to correct a received signal for the NL distortion. This may include digital post distortion (DPoD) correction.

As shown by reference number 515, the first WCD may decode the communication based on the estimated NL of the communication.

As indicated above, FIG. 5 is provided as an example. Other examples may differ from what is described with regard to FIG. 5.

The example 500 of FIG. 5 may be sufficient for communications between a stationary second WCD (e.g., a network node) and a non-stationary first WCD (e.g., a UE). However, when the first WCD and the second WCD are both non-stationary (e.g., when both are UEs), power amplification and NL parameters may vary enough to degrade performance of NL estimation from DMRSs. Additionally, or alternatively, DMRS patterns and/or NL effects may vary enough to degrade performance of NL correction.

In some aspects described herein, a transmitting WCD may transmit a communication with a signal scrambled with a first scrambling on a first symbol of a communication and with a second scrambling on a second symbol of the communication. In some examples, a sensing signal (e.g., for use in positioning information and/or RADAR, among other examples) may include a signal transmitted via multiple symbols to increase sensitivity of a measurement of a reflection of the sensing signal after reflecting off of an object. Based at least in part on using different scrambling on the multiple symbols, a WCD may reduce self-interference and improve isolation of the reflection of the sensing signal. This may support improved positioning of the object. For example, the NL distortion will be “processed out,” while a coherent combining of the signal would not (e.g., would remain after descrambling and combining). Distortion is reduced with the scrambling based at least in part on the signal within the first symbol and the signal within the second symbol being received with different phasing and will partially cancel out to improve isolation.

In some aspects, a first WCD may transmit a communication (e.g., a sidelink communication) with multiple symbols allocated for AGC. Based at least in part on the first WCD transmitting an AGC signal with a first scrambling on a first AGC symbol and transmitting the AGC signal with a second scrambling on a second AGC symbol, the WCD may calibrate AGC gain and gain additional information from the scrambling. For example, the WCD may descramble the AGC signal on each of the first and second AGC symbols and then combine the descrambled signal from the first symbol and from the second symbol. Based at least in part on the AGC signal having different scrambling in an over-the-air signal, the NL may be at least partially canceled when the AGC signal is combined after descrambling.

For example, in vehicle-to-anything (V2X) signals (e.g., sidelink signals), an expected dynamic range of a reception signal is relatively large, such as 80 dB. To compensate for the dynamic range being relatively large, the communication may include one or more AGC symbols, to allow the receiving WCD to configure an AGC gain. For example, the receiving WCD may use the one or more AGC symbols for an AGC process (e.g., energy measurement, gain calculation, indicating a gain command, and/or an analog settling time, among other examples).

In some aspects, the communication may include multiple AGC symbols based at least in part on an AGC process taking more time than a single symbol (e.g., for large subcarrier spacing channels).

To minimize the NL effects in the decoder, estimated log-likelihood ratios (LLRs) at symbols “0” and “1” are combined, to mitigate the performance loss due to the reception antenna front end nonlinearity in both symbols. However, if the NL effect is similar between the symbols, which may be the case if the signal is repeated “as is,” then the gain is limited.

However, based at least in part on applying different scrambling to the symbols (e.g., carrying the same signal with different scrambling), NL effects may be reduced, and the receiving WCD may benefit (e.g., in a same manner as in the radar use case) from processing gain from combining the symbols.

In some aspects, to improve the benefits of different scrambling, a scrambling applied to the first symbol and a scrambling applied to the second symbol may be non-repeating.

FIG. 6 is a diagram of an example 600 associated with symbol scrambling for combining in a communication from a first WCD to a second WCD, in accordance with the present disclosure. As shown in FIG. 6, a first WCD (e.g., a UE 120, a network node 110, a CU, a DU, and/or an RU) may communicate with a second WCD (e.g., a UE 120, a network node 110, a CU, a DU, and/or an RU). In some aspects, the first WCD and the second WCD may be part of a wireless network (e.g., wireless network 100). The UE and the network node may have established a wireless connection (e.g., sidelink or Uu) prior to operations shown in FIG. 6.

As shown by reference number 605, the first WCD may transmit, and the second WCD may receive, a first communication including first symbols carrying a same signal with different scrambling applied. In this way, a value of the signal may be in a different location (e.g., in a time domain) in the first symbol than in the second symbol. In some aspects, the first communication may include a first symbol carrying a first signal that has first scrambling applied and a second symbol carrying the first signal that has second scrambling applied. The first scrambling is different from the second scrambling so that the first signal is not received as an identical signal over-the-air (e.g., even though it is the same signal after descrambling).

Scrambling may refer to applying an algorithm to the first signal to encrypt or otherwise modify the first signal into a scrambled signal, such that the second WCD may descramble the scrambled signal based at least in part on the algorithm and/or parameters of the algorithm. For example, the signal may be used as input to a scrambling algorithm, and the scrambling algorithm may output the scrambled signal. In some cases, other WCDs (e.g., unintended recipients) may be unable to descramble the scrambled signal based at least in part on the other WCDs not having knowledge of the scrambling algorithm and/or one or more parameters of the scrambling algorithm. As used in context of reference number 605, the first WCD may apply a first scrambling algorithm (or first set of parameters to the scrambling algorithm) to the signal, producing a first scrambling of the signal, and may apply a second scrambling algorithm (or second set of parameters to the scrambling algorithm) to the signal, producing a second scrambling of the signal.

In some aspects, the first symbol and the second symbol are allocated for AGC. In this way, the first signal may be used by the second WCD to identify an AGC gain to apply to remaining symbols of the communication and/or the second WCD may use the AGC symbols to estimate NL for NL correction for the first communication.

As shown by reference number 610, the second WCD may descramble the signal. For example, the second WCD may descramble the first signal on the first symbol and descramble the first signal on the second symbol. In some aspects, the second WCD may be aware of the first scrambling and the second scrambling (e.g., scrambling patterns).

As shown by reference number 615, the second WCD may combine the descrambled signal. In some aspects, the second WCD may combine (e.g., using LLR-based combining) the descrambled first signal from the first symbol and the descrambled first signal from the second symbol.

As shown by reference number 620, the second WCD may decode the first communication. For example, the second WCD may decode the first communication based at least in part on the combination of the descrambled first signal from the first symbol and the descrambled first signal from the second symbol. In this way, the decoding may have an AGC applied based at least in part on measuring signal strengths via the first symbol and the second symbol and may have improved NL correction.

As shown by reference number 625, the second WCD may transmit, and the first WCD may receive, a second communication including first symbols carrying a same signal with different scrambling applied. For example, the second communication may include a third symbol carrying a second signal that has third scrambling applied and a fourth symbol carrying the second signal that has fourth scrambling applied. The third scrambling is different from the fourth scrambling so that the second signal is not received as an identical signal over-the-air (e.g., even though it is the same signal after descrambling).

In some aspects, the third symbol and the fourth symbol are allocated for AGC. In this way, the first signal may be used for the first WCD to identify an AGC gain to apply to remaining symbols of the communication and/or the first WCD may use the AGC symbols to estimate NL for NL correction for the second communication.

As shown by reference number 630, the first WCD may descramble the signal. For example, the first WCD may descramble the second signal on the third symbol and descramble the second signal on the fourth symbol. In some aspects, the first WCD may be aware of the first scrambling and the second scrambling (e.g., scrambling patterns).

As shown by reference number 635, the first WCD may combine the descrambled signal. In some aspects, the first WCD may combine (e.g., using LLR-based combining) the descrambled second signal from the third symbol and the descrambled second signal from the fourth symbol.

As shown by reference number 640, the first WCD may decode the second communication. For example, the first WCD may decode the second communication based at least in part on the combination of the descrambled second signal from the third symbol and the descrambled second signal from the fourth symbol. In this way, the decoding may have an AGC applied based at least in part on measuring signal strengths via the first symbol and the second symbol and may have improved NL correction.

As shown in FIG. 6, the scrambling may be used in one or both directions of communications between the first WCD and the second WCD. For example, the different scrambling on AGC symbols of a communication may be applied to uplink communications, downlink communications, and/or sidelink communications.

In some aspects, the first signal and/or the second signal may include reference signals, repetitions of data signaling, and/or repetitions of control signaling, among other examples. For example, the repetitions of control signaling or data signaling may include repetitions of a first non-AGC symbol of the communication. In some aspects, the first signal and/or the second signal include a non-repeating sequence within the first symbol and the second symbol or within the third symbol and the fourth symbol.

In some aspects, the first signal and/or the second signal may be configured for peak-to-average power ratio (PAPR) reduction or another communication benefit. Alternatively, the scrambling may include applying any known sequence with arbitrary randomness.

Based at least in part on transmitting a communication with different scrambling applied to a same signal (e.g., an AGC signal or a sensing signal) with different scrambling on different symbols, the described techniques can be used to reduce an effect of nonlinearity while supporting calibration of amplifiers. In this way, WCDs may communicate with improved SINR and/or SNR, which may improve spectral efficiency and/or reduce communication errors. Based at least in part on improving spectral efficiency and/or reducing communication errors, the WCDs may conserve communication, processing, power, and/or networking resources that may have otherwise been consumed based at least in part on communicating with reduced modulation orders, coding rates, and/or layers or detecting and correcting communication errors.

As indicated above, FIG. 6 is provided as an example. Other examples may differ from what is described with respect to FIG. 6.

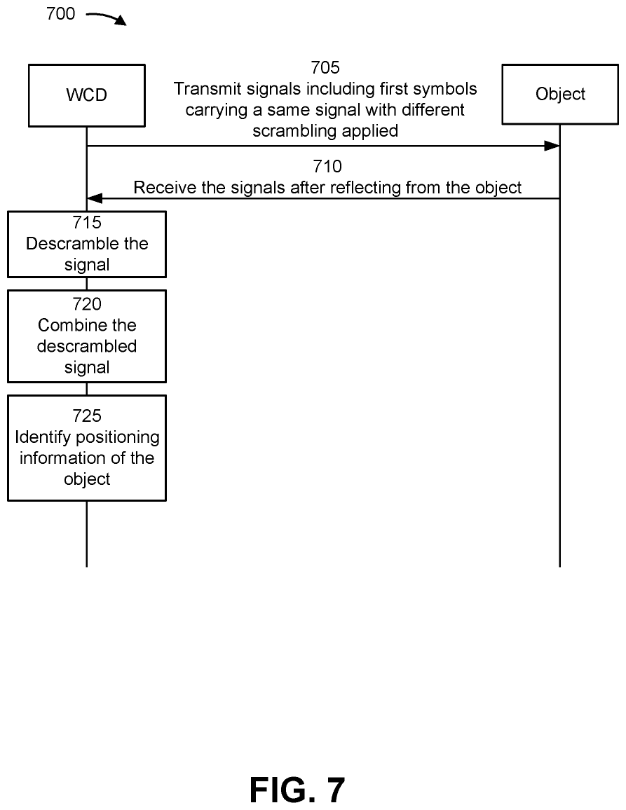

FIG. 7 is a diagram of an example 700 associated with symbol scrambling for sensing signals, in accordance with the present disclosure. As shown in FIG. 7, a WCD (e.g., a UE 120, a network node 110, a CU, a DU, and/or an RU) may transmit signals used to obtain positioning information associated with an object.

As shown by reference number 705, the WCD may transmit signals including first symbols carrying a same signal with different scrambling applied. In this way, a value of the signal may be in a different location (e.g., in a time domain) in the first symbol than in the second symbol. For example, the signals may include a first symbol carrying a first signal that has first scrambling applied and a second symbol carrying the first signal that has second scrambling applied. The first scrambling is different from the second scrambling so that the first signal is not received as an identical signal over-the-air (e.g., even though it is the same signal after descrambling).

In some aspects, the signals may include a sensing reference signal and/or other signaling in association with obtaining positioning information of an object. For example, the signals may include an existing reference signal (e.g., a configured type of reference signal), a modified existing reference signal (e.g., a sidelink waveform with a configurable number of AGC-like symbols), and/or a new resource with a number of symbols, predefined modulation, and/or a configured bandwidth, among other examples.

In some aspects, the signal may include a non-repeating sequence within the first symbol and the second symbol.

As shown by reference number 710, the WCD may receive the signals after the signals are reflected from the object. In some aspects, the WCD may receive the signals using a same antenna used to transmit the signals. Alternatively, the WCD may use a different antenna to receive the antenna than the antenna used to transmit the signals.

As shown by reference number 715, the WCD may descramble the signal. For example, the WCD may descramble the signal on the first symbol and descramble the signal on the second symbol. Based at least in part on the WCD performing the scrambling, the WCD may use the configuration used for scrambling to descramble the signal.

As shown by reference number 720, the WCD may combine the descrambled signal. In some aspects, the WCD may combine (e.g., using LLR-based combining) the descrambled signal from the first symbol and the descrambled signal from the second symbol.

As shown by reference number 725, the WCD may identify the positioning information of the object. For example, the WCD may use the combined descrambled signal to identify a location, speed, velocity, and/or trajectory of the object.

As indicated above, FIG. 7 is provided as an example. Other examples may differ from what is described with respect to FIG. 7.

In the examples described in connection with FIGS. 6 and 7, a transmitting WCD may apply scrambling with a long enough cycle to avoid repetition within the scrambling pattern. The signal and/or communication may include an uplink, downlink, or sidelink communication or transmission. A receiving WCD may perform descrambling as a part of the decoding, and then perform LLR combining.

FIG. 8 is a diagram illustrating an example process 800 performed, for example, by a WCD, in accordance with the present disclosure. Example process 800 is an example where the WCD (e.g., UE 120 or network node 110) performs operations associated with symbol scrambling for combining.

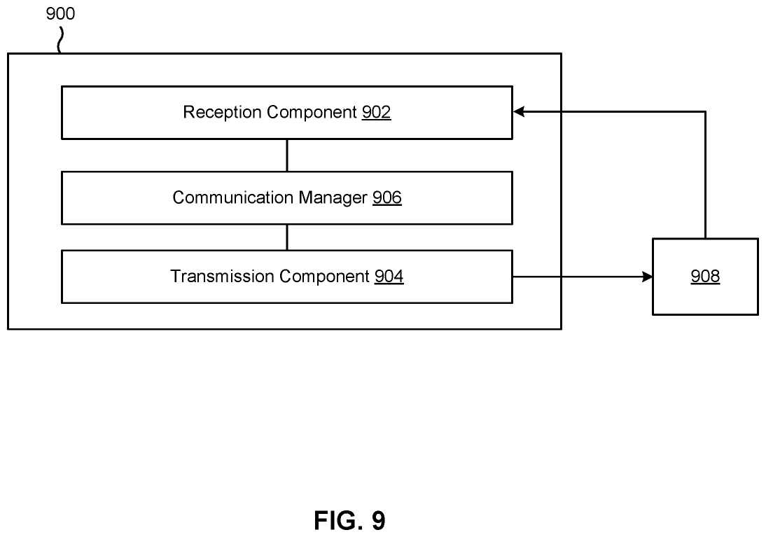

As shown in FIG. 8, in some aspects, process 800 may include transmitting signals via a set of symbols, the set of symbols including a first symbol carrying a first signal that has first scrambling applied and a second symbol carrying the first signal that has second scrambling applied, the first scrambling being different from the second scrambling (block 810). For example, the WCD (e.g., using transmission component 904 and/or communication manager 906, depicted in FIG. 9) may transmit signals via a set of symbols, the set of symbols including a first symbol carrying a first signal that has first scrambling applied and a second symbol carrying the first signal that has second scrambling applied, the first scrambling being different from the second scrambling, as described above.

Process 800 may include additional aspects, such as any single aspect or any combination of aspects described below and/or in connection with one or more other processes described elsewhere herein.

In a first aspect, the WCD comprises a first WCD, and the signals comprise a communication to a second WCD.

In a second aspect, the first symbol and the second symbol are allocated for AGC.

In a third aspect, process 800 includes receiving an additional communication from the second WCD, the additional communication comprising a set of symbols that include a third symbol carrying a second signal and having third scrambling applied and a fourth symbol carrying the second signal and having fourth scrambling applied, the third scrambling being different from the fourth scrambling.

In a fourth aspect, process 800 includes descrambling the second signal on the third symbol, descrambling the second signal on the fourth symbol, combining the descrambled second signal from the third symbol and the descrambled second signal from the third symbol, and decoding the second signal based at least in part on the combination of the descrambled second signal from the third symbol and the descrambled second signal from the third symbol.

In a fifth aspect, process 800 includes receiving the signals in association with identification of positioning information of an object.

In a sixth aspect, the first signal comprises one or more of sensing signals, reference signals, repetitions of data signaling, or repetitions of control signaling.

In a seventh aspect, the first signal comprises a non-repeating sequence within the first symbol or the second symbol.

In an eighth aspect, the first signal is configured for peak-to-average power ratio reduction.

In a ninth aspect, the first symbol and the second symbol comprise one or more of consecutive symbols, or symbols within a single subframe.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a WCD, or a WCD may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 or 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 6-7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the WCD described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the WCD described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the WCD described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit signals via a set of symbols, the set of symbols including a first symbol carrying a first signal that has first scrambling applied and a second symbol carrying the first signal that has second scrambling applied, the first scrambling being different from the second scrambling.

The reception component 902 may receive an additional communication from the second WCD, the additional communication comprising a set of symbols that include a third symbol carrying a second signal and having third scrambling applied and a fourth symbol carrying the second signal and having fourth scrambling applied, the third scrambling being different from the fourth scrambling.

The communication manager 906 may descramble the second signal on the third symbol.

The communication manager 906 may descramble the second signal on the fourth symbol.

The communication manager 906 may combine the descrambled second signal from the third symbol and the descrambled second signal from the third symbol.

The communication manager 906 may decode the second signal based at least in part on the combination of the descrambled second signal from the third symbol and the descrambled second signal from the third symbol.

The reception component 902 may receive the signals in association with identification of positioning information of an object.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a wireless communication device (WCD), comprising: transmitting signals via a set of symbols, the set of symbols including a first symbol carrying a first signal that has first scrambling applied and a second symbol carrying the first signal that has second scrambling applied, the first scrambling being different from the second scrambling.

Aspect 2: The method of Aspect 1, wherein the WCD comprises a first WCD, and wherein the signals comprise a communication to a second WCD.

Aspect 3: The method of Aspect 2, wherein the first symbol and the second symbol are allocated for automatic gain control (AGC).

Aspect 4: The method of Aspect 2, further comprising: receiving a second communication from the second WCD, the second communication comprising a second set of symbols that include a third symbol carrying a second signal and having third scrambling applied and a fourth symbol carrying the second signal and having fourth scrambling applied, the third scrambling being different from the fourth scrambling.

Aspect 5: The method of Aspect 4, further comprising: descrambling the second signal on the third symbol; descrambling the second signal on the fourth symbol; combining the descrambled second signal from the third symbol and the descrambled second signal from the third symbol; and decoding the second signal based at least in part on the combination of the descrambled second signal from the third symbol and the descrambled second signal from the third symbol.

Aspect 6: The method of any of Aspects 1-5, further comprising: further comprising: receiving the signals in association with identification of positioning information of an object.

Aspect 7: The method of any of Aspects 1-6, wherein the first signal comprises one or more of: sensing signals, reference signals, repetitions of data signaling, or repetitions of control signaling.

Aspect 8: The method of any of Aspects 1-7, wherein the first signal comprises a non-repeating sequence within the first symbol or the second symbol.

Aspect 9: The method of any of Aspects 1-8, wherein the first signal is configured for peak-to-average power ratio reduction.

Aspect 10: The method of any of Aspects 1-8, wherein the first symbol and the second symbol comprise one or more of: consecutive symbols, or symbols within a single subframe.

Aspect 11: An apparatus for wireless communication at a device, comprising a processor; memory coupled with the processor; and instructions stored in the memory and executable by the processor to cause the apparatus to perform the method of one or more of Aspects 1-10.

Aspect 12: A device for wireless communication, comprising a memory and one or more processors coupled to the memory, the one or more processors configured to perform the method of one or more of Aspects 1-10.

Aspect 13: An apparatus for wireless communication, comprising at least one means for performing the method of one or more of Aspects 1-10.

Aspect 14: A non-transitory computer-readable medium storing code for wireless communication, the code comprising instructions executable by a processor to perform the method of one or more of Aspects 1-10.

Aspect 15: A non-transitory computer-readable medium storing a set of instructions for wireless communication, the set of instructions comprising one or more instructions that, when executed by one or more processors of a device, cause the device to perform the method of one or more of Aspects 1-10.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wireless communication device (WCD) for wireless communication, comprising:
one or more memories; and
one or more processors, coupled to the one or more memories, configured to:
transmit signals via a set of symbols, the set of symbols including a first symbol carrying a first signal that has first scrambling applied and a second symbol carrying the first signal that has second scrambling applied, the first scrambling being different from the second scrambling.

2. The WCD of claim 1, wherein the WCD comprises a first WCD, and
wherein the signals comprise a communication to a second WCD.

3. The WCD of claim 2, wherein the first symbol and the second symbol are allocated for automatic gain control (AGC).

4. The WCD of claim 2, wherein the communication is a first communication and the set of symbols is a first set of symbols, and
wherein the one or more processors are further configured to receive a second communication from the second WCD, the second communication comprising a second set of symbols that include a third symbol carrying a second signal and having third scrambling applied and a fourth symbol carrying the second signal and having fourth scrambling applied, the third scrambling being different from the fourth scrambling.

5. The WCD of claim 4, wherein the one or more processors are further configured to:
descramble the second signal on the third symbol;
descramble the second signal on the fourth symbol;
combine the descrambled second signal from the third symbol and the descrambled second signal from the third symbol; and
decode the second signal based at least in part on the combination of the descrambled second signal from the third symbol and the descrambled second signal from the third symbol.

6. The WCD of claim 1, wherein the one or more processors are further configured to:
receive the signals in association with identification of positioning information of an object.

7. The WCD of claim 1, wherein the first signal comprises one or more of:
sensing signals,
reference signals,
repetitions of data signaling, or
repetitions of control signaling.

8. The WCD of claim 1, wherein the first signal comprises a non-repeating sequence within the first symbol or the second symbol.

9. The WCD of claim 1, wherein the first signal is configured for peak-to-average power ratio reduction.

10. The WCD of claim 1, wherein the first symbol and the second symbol comprise one or more of:
consecutive symbols, or
symbols within a single subframe.

11. A method of wireless communication performed by a wireless communication device (WCD), comprising:
transmitting signals via a set of symbols, the set of symbols including a first symbol carrying a first signal that has first scrambling applied and a second symbol carrying the first signal that has second scrambling applied, the first scrambling being different from the second scrambling.

12. The method of claim 11, wherein the WCD comprises a first WCD, and
wherein the signals comprise a communication to a second WCD.

13. The method of claim 12, wherein the first symbol and the second symbol are allocated for automatic gain control (AGC).

14. The method of claim 12, further comprising:
receiving a second communication from the second WCD, the second communication comprising a second set of symbols that include a third symbol carrying a second signal and having third scrambling applied and a fourth symbol carrying the second signal and having fourth scrambling applied, the third scrambling being different from the fourth scrambling.

15. The method of claim 14, further comprising:
descrambling the second signal on the third symbol;
descrambling the second signal on the fourth symbol;
combining the descrambled second signal from the third symbol and the descrambled second signal from the third symbol; and
decoding the second signal based at least in part on the combination of the descrambled second signal from the third symbol and the descrambled second signal from the third symbol.

16. The method of claim 11, further comprising:
receiving the signals in association with identification of positioning information of an object.

17. The method of claim 11, wherein the first signal comprises one or more of:
sensing signals,
reference signals,
repetitions of data signaling, or
repetitions of control signaling.

18. The method of claim 11, wherein the first signal comprises a non-repeating sequence within the first symbol or the second symbol.

19. The method of claim 11, wherein the first signal is configured for peak-to-average power ratio reduction.

20. The method of claim 11, wherein the first symbol and the second symbol comprise one or more of:
consecutive symbols, or
symbols within a single subframe.

21. A non-transitory computer-readable medium storing a set of instructions for wireless communication, the set of instructions comprising:
one or more instructions that, when executed by one or more processors of a wireless communication device (WCD), cause the WCD to:
transmit signals via a set of symbols, the set of symbols including a first symbol carrying a first signal that has first scrambling applied and a second symbol carrying the first signal that has second scrambling applied, the first scrambling being different from the second scrambling.

22. The non-transitory computer-readable medium of claim 21, wherein the WCD comprises a first WCD, and
wherein the signals comprise a communication to a second WCD.

23. The non-transitory computer-readable medium of claim 22, wherein the first symbol and the second symbol are allocated for automatic gain control (AGC).

24. The non-transitory computer-readable medium of claim 21, wherein the one or more instructions further cause the WCD to:
receive the signals in association with identification of positioning information of an object.

25. The non-transitory computer-readable medium of claim 21, wherein the first signal comprises one or more of:
sensing signals,
reference signals,
repetitions of data signaling, or
repetitions of control signaling.

26. An apparatus for wireless communication, comprising:
means for transmitting signals via a set of symbols, the set of symbols including a first symbol carrying a first signal that has first scrambling applied and a second symbol carrying the first signal that has second scrambling applied, the first scrambling being different from the second scrambling.

27. The apparatus of claim 26, wherein the apparatus comprises a first apparatus, and
wherein the signals comprise a communication to a second apparatus.

28. The apparatus of claim 27, wherein the first symbol and the second symbol are allocated for automatic gain control (AGC).

29. The apparatus of claim 26, further comprising:
means for receiving the signals in association with identification of positioning information of an object.

30. The apparatus of claim 26, wherein the first signal comprises one or more of:
sensing signals,
reference signals,
repetitions of data signaling, or
repetitions of control signaling.
